(19) United States
(12) Patent Application Publication
(10) Pub. No.: US 2025/0151087 A1
(43) Pub. Date: May 8, 2025

(54) METHODS AND SYSTEMS FOR INTER-UE COORDINATION SCHEME1

(71) Applicant: Apple Inc., Cupertino, CA (US)

(72) Inventors: Chunxuan Ye, San Diego, CA (US); Dawei Zhang, Saratoga, CA (US); Weidong Yang, San Diego, CA (US); Chunhai Yao, Beijing (CN); Yushu Zhang, Beijing (CN); Haitong Sun, Cupertino, CA (US); Hong He, San Jose, CA (US); Wei Zeng, Saratoga, CA (US); Oghenekome Oteri, San Diego, CA (US); Seyed Ali Akbar Fakoorian, San Diego, CA (US)

(21) Appl. No.: 18/836,844

(22) PCT Filed: Feb. 11, 2022
(86) PCT No.: PCT/CN2022/076021

§ 371 Date: Aug. 8, 2024

(51) Int. Cl. H04W 72/25; H04W 72/0446

(52) U.S. Cl. CPC H04W 72/25; H04W 72/0446

(57) ABSTRACT

A user equipment including a transceiver and a processor is disclosed. The processor is configured to determine a sidelink control information (SCI) format payload size based on resource pool configuration for the UE for inter-UE coordination with a second UE. The processor is configured to determine, based on the determined SCI format payload size, an SCI format including a number of message elements identifying attributes of a number of resources being used by the UE over a predetermined time period. The processor is configured to encode and transmit, to the second UE, the SCI format for the IUC for resource selection by the second UE.

### TECHNICAL FIELD

Embodiments described herein generally relate to sidelink communication between user equipments (UEs) and, more particularly, to sidelink communication used for inter-UE coordination of resource selection to avoid a resource collision in which both of the UEs select the same resource for transmission during the same time.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 depicts an example environment in which embodiments described herein may be practiced.

FIG. 2 depicts an example flow chart for determining a payload size of a sidelink control information (SCI) format for inter-UE coordination (IUC) at a transmitting UE, in accordance with some embodiments.

FIG. 3 depicts another example flow chart for IUC, in accordance with some embodiments.

FIG. 4 depicts an example time-based event flow describing IUC, in accordance with some embodiments.

FIG. 5 depicts another example time-based event flow describing IUC, in accordance with some embodiments.

FIG. 6 depicts an example method flow chart for IUC, in accordance with some embodiments.

FIG. 7 depicts an example architecture of a wireless communication system of a cellular carrier domain, according to embodiments disclosed herein.

FIG. 8 depicts a system for performing signaling between a UE and a network device, according to embodiments disclosed herein.

### DETAILED DESCRIPTION

Reference will now be made in detail to representative embodiments/aspects illustrated in the accompanying drawings. It should be understood that the following description is not intended to limit the embodiments to one preferred embodiment. On the contrary, it is intended to cover alternatives, modifications, and equivalents as can be included within the spirit and scope of the described embodiments as defined by the appended claims.

Embodiments described herein include methods and apparatus (e.g., a user equipment (UE)) for performing an inter-UE coordination (IUC) procedure using a sidelink communication interface between the UEs. In particular, the embodiments described herein are related to a new sidelink control information (SCI) format for the IUC communication, and various time windows for selection of resources being used by a user equipment, and transmission of the SCI format for the IUC communication to another UE, thereby assisting the other UE in resource selection for its transmission. The UE receiving the SCI format describing resource selection by another UE may then select resources for its transmission in such a way that resource collision may be avoided. The embodiments described herein bypass communication between UEs via a base station (such as an eNodeB, eNB, gNB, access point, etc.). The UEs send the SCI format via the sidelink communication interface.

In some embodiments described herein, a new SCI format for an explicit request to another UE to send its resource information describing the resources to be used by the UE is described. The same SCI format may also be used to transmit the resource information to the UE which requested the resource information. In some embodiments, and by way of a non-limiting example, a UE may also send resource information to another UE without an explicit request from the other UE to send the resource information. The UE may transmit to the other UE the resource information upon meeting a specific criterion, for example, the UE may be (pre)configured to send the resource information periodically to other UEs.

In some embodiments, a procedure for resource selection for transmission of the SCI format for IUC is described. In some embodiments, the UE may specify resources being used for transmission according to a time window specified in an explicit request for resource information received from another UE. In some embodiments, the UE sending an explicit request for the resource information may also specify a time period by which the resource information in the SCI format should be received.

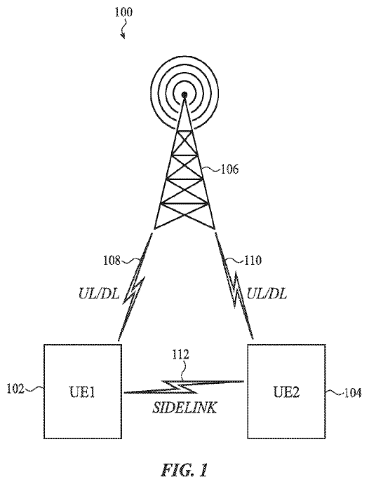

FIG. 1 depicts an example environment in which embodiments described herein may be practiced. As shown in FIG. 1, an example environment 100 may include a UE1 102, a UE2 104, and a base station 106. The base station 106 may be an access point, an eNodeB, an eNB, a gNB, etc. Though only two UEs are shown in FIG. 1, there may be more than two UEs in the example environment 100. In some embodiments, and by way of a non-limiting example, a UE may be a phone, a tablet, a smartphone, an Internet-of-Things device, a vehicle, etc. Each of the UE1 102 and the UE2 104 may be communicatively coupled with the base station 106 and may receive data in a downlink (DL) direction from the base station and may transmit data in an uplink (UL) direction. For example, as shown in FIG. 1, the UE1 may exchange data with the base station 106 in an UL direction and a DL direction over a link 108, and the UE2 may exchange data with the base station 106 in an UL direction and a DL direction over a link 110. In addition, the UE1 102 and the UE2 104 may communicate with each other using a sidelink communication interface 112, and thereby avoid communicating via the base station. In particular, as described herein, the UE1 102 and the UE2 104 may communicate with each other over the sidelink communication interface 112 for inter-UE coordination (IUC).

In some embodiments, as described herein, the inter-UE coordination may describe the resources being used by a UE for within a specific time period to another UE, so that the other UE may select its resources without causing resource collision. In some embodiments, for example, the UE2 104 may send a request to the UE1 102 to send its resource information describing the resources being used by the UE1 102 over a specific time period. The request from the UE2 104 to the UE1 102 may be sent over the sidelink communication interface 112. The request may be sent using a new SCI format that is described in detail herein. The UE1 102 may then send the requested resource information using the same new SCI format to the UE2 104. Thus, the same new SCI format may be used for both the request and the response messages.

In some embodiments, and by way of a non-limiting example, one bit may be reserved in the new SCI format to identify whether the new SCI format is carrying content to request resource information (or IUC information) or to provide resource information (or IUC information). For example, one bit with its value set to 1 may indicate the new SCI format is carrying content to request resource information (or IUC information) and the one bit with its value set to 0 may indicate the new SCI format is carrying content to provide resource information (or IUC information), or vice versa.

In some embodiments, and by way of a non-limiting example, the request and the response messages for the IUC may use a Media Access Control (MAC) layer message control element (CE), a radio resource signaling (RRC) information message, and/or a new physical channel or interface to communicate with another UE for the IUC. Accordingly, a container for the IUC may be a new SCI format, a MAC CE, a RRC message element, and/or a new physical channel or interface element. However, as described herein, the present disclosure describes the new SCI format as the container for the IUC in detail.

The new SCI format may include a resource set in which a resource may be identified using one or more combinations (for example, N combinations, where N>=1) of a time resource indicator value (TRIV), a frequency resource indicator value (FRIV), and its periodicity (or a resource reservation period), as described in detail in section 8.1.5 of 3GPP TS 38.214 titled “5G; NR; Physical layer procedures for data,” version 16.2.0 released July 2020. In some embodiments, and by way of a non-limiting example, the periodicity or the resource reservation period may be omitted in the SCI format when the IUC communication to transmit the resource information is being performed in response to an explicit request received from another UE. In other words, the UE1 102 may omit the periodicity or the resource reservation period in the new SCI format when the UE1 102 is building and sending the new SCI format describing its resource information identifying resources being used in response to a request received from the UE2 104.

In some embodiments, a first resource location of each TRIV may be separately indicated or identified in the new SCI format. In some embodiments, when a total number of combinations is not more than three (e.g., N<=3), a MAC CE or a new SCI format or both may be used by a UE for requesting and/or indicating resource information. When the total number of combinations is more than three, then a MAC CE may be used by a UE for requesting and/or indicating resource information. In this disclosure, a value of 3 for the total number of combinations N is used as an example only, and a UE may use a MAC CE or a new SCI format or both according to a (pre)configured or predetermined value of the total number of combinations N.

In some embodiments, and by way of a non-limiting example, UE capability information may also be included in the new SCI format. Various embodiments described in the present disclosure are related to determining content of the new SCI format and building and sending the new SCI format as encoded at a selected time identified by a time slot or a resource.

As described herein in accordance with some embodiments, the new SCI format may be referenced as an SCI format 2-C, for example. The SCI format 2-C may include fields that are included in an SCI format 2-A that describe a source identification (ID), a destination ID, a hybrid automatic repeat request (HARQ) process field, a new data indicator field, a redundancy version field, a HARQ feedback enabled/disabled indicator field, a cast type indicator field, and a CSI request field.

In some embodiments, and by way of a non-limiting example, a total number of bits that are included in the SCI format 2-C from the SCI format 2-A may be 35 bits formed from 4 bits for the HARQ process field, 1 bit for the new data indicator field, 2 bits for the redundancy version field, 8 bits for the source ID and 16 bits for the destination ID, 1 bit for the HARQ feedback enabled/disabled indicator field, 2 bits for the cast type indicator field, and 1 bit for the CSI request field.

In some embodiments, and by way of a non-limiting example, the cast type indicator may not be used if the explicit request for the resource information and the resource information being sent for the IUC is used for unicast transmission.

In some embodiments, the SCI format 2-C may include fields that are included in an SCI format 2-B that describe a zone ID and a communication range requirement field. In some embodiments, and by way of a non-limiting example, the zone ID and the communication range requirement field may have common bits as the CSI request field.

In some embodiments, and by way of a non-limiting example, a total number of bits that are included in the SCI format 2-C from the SCI format 2-B may be 16 bits formed from 12 bits for the zone ID field and 4 bits for the communication range requirement field.

In some embodiments, and by way of a non-limiting example, a value of infinity may be used in the communication range requirement field. In some embodiments, the value of infinity may be used for non-distance-based NACK-only HARQ feedback for groupcast transmission.

In some embodiments, the SCI format 2-C may also include a format indicator field. The format indicator field may indicate whether the SCI format 2-C is used for an explicit request for receiving resource information or to send resource information for IUC. By way of a non-limiting example, the format indicator field may be of 1 bit.

In some embodiments, when the format indicator field is set to indicate whether the SCI format 2-C is used for an explicit request, the SCI format 2-C may include a starting location and an ending location of a resource selection window, a latency bound of the IUC field, a resource type field, a priority value, a number of sub-channels to be used for PSCCH and/or PSSCH transmission, and a resource reservation interval.

In some embodiments, and by way of a non-limiting example, the starting location and the ending location of the resource selection window, and the latency bound of the IUC field may be 17 bits in length, of which 10 bits may be used for a direct frame number (DFN) and 7 bits may be used for a slot index. In some embodiments, for example, the starting location and the ending location of the resource selection window may be 14+u bits in length, of which 10 bits may be used for a direct frame number (DFN) and 4+u number of bits may be used for a slot index, where the value of u may be 0, 1, 2, and 3 for a sub-carrier spacing of 15 kHz, 30 kHz, 60 kHz, and 120 kHz, respectively, for the resource pool. By way of a non-limiting example, the latency bound of the IUC field may indicate a time delay or by when a UE must receive a response for the IUC.

In some embodiments, and by way of a non-limiting example, the resource type field may be 0 to 1 bit in length, depending on the (pre)configuration of the resource pool. The resource type field may be used to indicate whether the resources are preferred resources or non-preferred resources. The priority value used for PSCCH and/or PSSCH transmission may be 3 bits in length, and the number of sub-channels to be used for the PSCCH and/or PSSCH transmission may be 0 to 5 bits in length and calculated based on ┌log₂(N_{subchannel}^{SL})┐, for example, where ┌x┐ refers the smallest integer larger than or equal to x. In some embodiments, for example. the resource reservation interval may be calculated based on ┌log₂(Nᵣₛᵥ_{_{period}})┐, and thus may be 0 to 4 bits in length.

In some embodiments, when the format indicator field is set to indicate whether the SCI format 2-C is used to send resource information for IUC, the SCI format 2-C may include a field to indicate a total number of actually indicated combinations, for example, the field of a total number of actually indicated combinations may be represented as 1 bit or 2 bits based on a (pre)configured or pre-defined maximum number of combinations identified by Nₘₐₓ. In some embodiments, and by way of a non-limiting example, the total number of actually indicated combinations may be indicated by a code point of the first time resource location of each TRIV or a code point of the first frequency location of each FRIV.

In some embodiments, and by way of a non-limiting example, the total number of indicated combinations may be 12*Nₘₐₓ to 39*Nₘₐₓ bits in length plus 19 bits of other information, described in detail herein. The 12*Nₘₐₓ to 39*Nₘₐₓ bits in length may include a time location of the first resource in each TRIV of 3*Nₘₐₓ to 8*Nₘₐₓ bits calculated based on ┌log₂(Mₘₐₓ)┐; a starting sub-channel index of the first resource in each FRIV of 0 to 5*Nₘₐₓ bits calculated based on ┌log₂(N_{subchannel}^{SL})┐; and each combination of (TRIV, FRIV, periodicity) of 9*Nₘₐₓ to 26*Nₘₐₓ bits. Each combination of (TRIV, FRIV, periodicity) may include a TRIV of 9 bits, FRIV of less than or equal to 13 bits, and periodicity of 0 to 4 bits. The FRIV may be calculated based on ┌log₂((N_{subchannel}^{SL})(N_{subchannel}^{SL}+1)(2N_{subchannel}^{SL}+1)/6)┐. Mₘₐₓ may identify a maximum slot offset value. N^{SL}_{subchannel} may be of any value between 0 to 27.

In some embodiments, and by way of a non-limiting example, a code point of the first time resource location of a TRIV or a code point of the first frequency location of a FRIV of all 1's may be used to indicate that a combination of (TRIV, FRIV, periodicity) is invalid or unused. In some embodiments, and by way of a non-limiting example, if a value for the code point of the first time resource location of a TRIV or the first frequency location of a FRIV matches a (pre)defined code point, then a corresponding combination of (TRIV, FRIV, periodicity) may be ignored. But when there is a mismatch between a value for the code point of the first time resource location of a TRIV or the first frequency location of a FRIV and a (pre)defined code point, a corresponding combination of (TRIV, FRIV, periodicity) may not be ignored for encoding and transmitting in the SCI format 2-C for IUC.

In some embodiments, the 19 bits of other information may include a reference slot index of 17 bits, 1 bit of a resource set type field, and 1 bit field to indicate the number of actually indicated combinations. By way of a non-limiting example, the reference slot index of 17 bits may include 10 bits describing a direct frame number and 7 bits for describing a slot index. In some embodiments, for example, the reference slot index may be of 14+u bits, where u corresponds to 0, 1, 2, or 3 for a sub-carrier spacing of 15 kHz, 30 kHz, 60 kHz, and 120 kHz, respectively. In some embodiments, for example, the reference slot index may be omitted if the reference slot index is the same as or implicitly derived from the IUC transmission slot information. In some embodiments, the resource set type field may be the same for the explicit request and for a response for the IUC. If the resource pool (pre)configures the explicit request to indicates a resource set type, and IUC is triggered by a condition other than explicit request is not (pre)configured, then the size of the resource set type field may be of 0 bit length. Otherwise, the size of the resource set type field may be of 1 bit length. Depending on the value set for the resource set type field, the UE may include either preferred or non-preferred resource in the IUC.

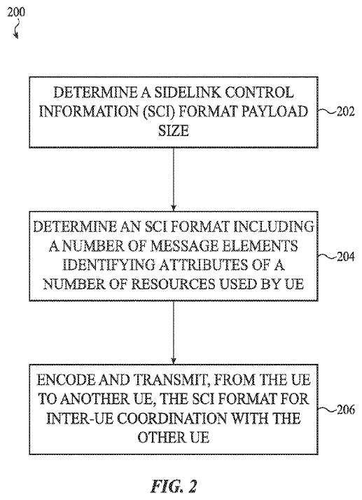

FIG. 2 depicts an example flow chart for determining a payload size of a sidelink control information (SCI) format for inter-UE coordination (IUC) at a transmitting UE, in accordance with some embodiments. A flow chart 200 shown in FIG. 2 describes operations of a method to send resource information for the IUC using the SCI format 2-C as described herein. At 202, a sidelink control information (SCI) format payload size may be determined. As described herein the SCI format payload may be dependent on whether the SCI format, for example, the SCI format 2-C, is used in an explicit request to receive resource information or to send resource information. Further, the SCI format 2-C payload size may also be dependent on the total number of maximum combinations as described herein when the SCI format 2-C is for sending the resource information to another UE. Accordingly, as described herein in accordance with various embodiments, the SCI format 2-C payload size may be determined for a UE transmitting the SCI format 2-C to another UE for IUC.

In some embodiments, a UE receiving the SCI format 2-C for IUC may also determine a payload size for the received SCI format 2-C based on a resource pool (pre)configuration and resource set type field's value. Accordingly, once the SCI format 2-C payload size is determined by the UE receiving SCI format 2-C for IUC, content of the SCI format 2-C may be decoded as described herein.

In some embodiments, and by way of a non-limiting example, the SCI format 2-C payload size for the explicit request may be larger than a response for sending resource information for the IUC based on the Mₘₐₓ, N_{subchannel}, and Nᵣₛᵥ_{_{period}}. In some embodiments, a UE may determine the SCI format 2-C payload size as a maximum of a payload size for the IUC and a request received from the second UE for receiving resource information corresponding to the number of resources being used by the UE over the predetermined time period in the IUC.

At 204, once the SCI format 2-C payload size is determined, the SCI format 2-C, in other words, payload content or a number of message elements identifying attributes of a number of resources to be used by a UE, may be determined. The SCI format 2-C payload content may include various message elements of the SCI format 2-C as described herein in accordance with some attributes. As described herein, the SCI format 2-C message elements or payload content may include fields that are included in an SCI format 2-A that describe various attributes of the number of resources to be used by the UE including a source identification (ID), a destination ID, a HARQ process field, a new data indicator field, a redundancy version field, a HARQ feedback enabled/disabled indicator field, a cast type indicator field, and a CSI request field. The SCI format 2-C message elements or payload content may also include fields that are included in an SCI format 2-B that describe a zone ID and a communication range requirement field.

In some embodiments, the SCI format 2-C message elements or payload content may also include a format indicator field, as described herein, other fields based on the value of the format indicator field indicating either an explicit request to send resource information or sending resource information for the IUC. The SCI format 2-C message elements or payload content identifies attributes of one or more resources of a resource pool being used for transmission by a UE.

At 206, the SCI format 2-C payload content is encoded and transmitted to another UE using a sidelink communication interface between two UEs.

For example, in some embodiments, a UE receiving the SCI format 2-C at 206 may decode content of the SCI format 2-C after determining a payload size of the received SCI format 2-C. The format indicator field in the received SCI format 2-C may indicate whether the SCI format 2-C is used to send resource information for IUC, it may be determined that the SCI format 2-C includes a field to indicate a total number of actually indicated combinations, which may be represented as 1 bit or 2 bits based on a (pre)configured or pre-defined maximum number of combinations identified by Nₘₐₓ. In some embodiments, and by way of a non-limiting example, the total number of actually indicated combinations may be indicated by a code point of the first time resource location of each TRIV or a code point of the first frequency location of each FRIV.

In some embodiments, and by way of a non-limiting example, the total number of indicated combinations may be 12*Nₘₐₓ to 39*Nₘₐₓ bits in length plus 19 bits of other information, described in detail herein. The 12*Nₘₐₓ to 39*Nₘₐₓ bits in length may include a time location of the first resource in each TRIV of 3*Nₘₐₓ to 8*Nₘₐₓ bits calculated based on ┌log₂(Mₘₐₓ)┐; a starting sub-channel index of the first resource in each FRIV of 0 to 5*Nₘₐₓ bits calculated based on ┌log₂(N_{subchannel})┐; and each combination of (TRIV, FRIV, periodicity) of 9*Nₘₐₓ to 26*Nₘₐₓ bits. Each combination of (TRIV, FRIV, periodicity) may include a TRIV of 9 bits, FRIV of less than or equal to 13 bits, and periodicity of 0 to 4 bits. The FRIV may be calculated based on ┌log₂((N_{subchannel}^{SL})(N_{subchannel}^{SL}+1)(2N_{subchannel}^{SL}+1)/6)┐. Mₘₐₓ may identify a maximum slot offset value. N^{SL}_{subchannel} may be of any value between 0 to 27.

In some embodiments, and by way of a non-limiting example, a code point of the first time resource location of a TRIV or a code point of the first frequency location of a FRIV of all 1's may be used to indicate that a combination of (TRIV, FRIV, periodicity) is invalid or unused.

In some embodiments, the 19 bits of other information may include a reference slot index of 17 bits, 1 bit of a resource set type field, and 1 bit field to indicate the number of actually indicated combinations. By way of a non-limiting example, the reference slot index of 17 bits may include 10 bits describing a direct frame number and 7 bits for describing a slot index. In some embodiments, for example, the reference slot index may be of 14+u bits, where u corresponds to 0, 1, 2, or 3 for a sub-carrier spacing of 15 kHz, 30 kHz, 60 kHz, and 120 kHz, respectively. In some embodiments, for example, the reference slot index may be omitted if the reference slot index is the same as or implicitly derived from the IUC transmission slot information. In some embodiments, the resource set type field may be the same for the explicit request and for a response for the IUC. If the resource pool (pre)configures the explicit request that indicates a resource set type and IUC triggered by a condition other than explicit request is not (pre)configured, then the size of the resource set type field may be of 0 bit length. Otherwise, the size of the resource set type field may be of 1 bit length.

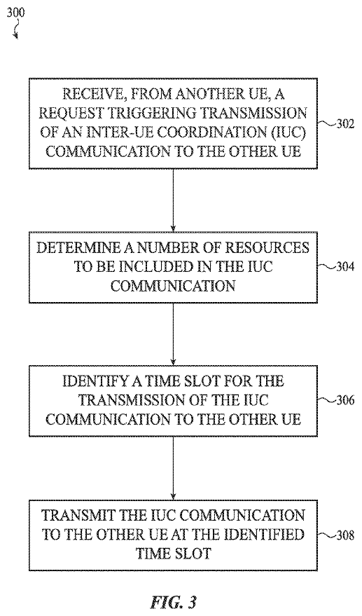

FIG. 3 depicts another example flow chart for IUC, in accordance with some embodiments. A flow chart 300 shown in FIG. 3 describes operations of a method to determine resource information corresponding to one or more resources of a resource pool being used by a UE, and to send to another UE using SCI format 2-C described herein at a selected timeslot.

At 302, a UE1 102 may receive an explicit request to trigger transmission of an IUC including resource information to a UE2 104.

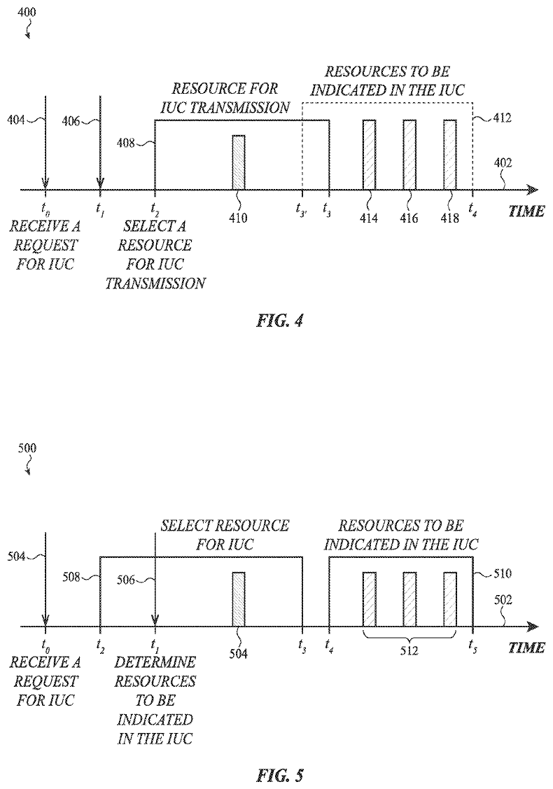

In some embodiments, for example, upon receiving the explicit request, at 304, the UE1 102 may determine a number of resources to be included in the SCI format 2-C for a particular time window for the IUC communication. In some embodiments, the UE1 102 may determine the number of resources to be included as described herein using FIG. 4 or FIG. 5.

In some embodiments, the UE1 102, at 306, may identify a time slot for transmitting the SCI format 2-C for the IUC communication as described herein using FIG. 4 or FIG. 5. At 308, the UE1 102 may transmit the SCI format 2-C at the time slot identified at 306.

FIG. 4 depicts an example time-based event flow describing IUC, in accordance with some embodiments. As shown in a time event flow 400, various events are shown along time 402. At time t₀, an explicit request to send resource information may be received 404 at a UE1 102 from a UE2 104 at a time slot n, for example. Upon receiving the explicit request at time t₀, the UE1 102 may determine resource information 412 of one or more resources 414, 416, and 418 to be included in the SCI format 2-C as described herein. The one or more resources 414, 416, and 418 to be included in the SCI format 2-C may correspond to a time window t₃′ and t₄. Accordingly, in some embodiments, and by way of a non-limiting example, a sensing window for selection of the one or more resource 414, 416, and 416 to be included in the SCI format 2-C may be [n−T0, n−Tproc.0]. At time t₁, a resource for IUC transmission may be determined 408. The resource for IUC transmission, for example, may be a resource 410 which may correspond to a resource between time window t₂ and t₃. As shown in FIG. 4, there may be some overlap between a time window from which a resource for transmission of the SCI format 2-C may be selected and a time window covering one or more resources of which resource information is sent in the SCI format 2-C.

In some embodiments, and by way of a non-limiting example, a time window covering one or more resources of which resource information is sent in the SCI format 2-C may be specified in an explicit request received from the UE1 104 at the UE1 102. In some embodiments, and by way of a non-limiting example, a time window covering one or more resources of which resource information is sent in the SCI format 2-C may be determined by the UE1 102 and may be determined based on meeting a specific criterion.

In some embodiments, and by way of a non-limiting example, a resource 410 selected for transmission of SCI format 2-C may be at a time slot m, for example, at time t₁, that is later than the time slot n, for example, at time t₀, at which an explicit request is received.

In some embodiments, the resource selection window for IUC transmission, for example, may not be later than a time slot corresponding to a first resource to be included in the SCI format 2-C for the IUC. In some embodiments, for example, the resource selection window for IUC transmission may not be later than a time window covering one or more resources of which resource information is sent in the SCI format 2-C, or the resource selection window for IUC transmission may not be later than a latency bound indicated in the explicit request received at time t₀. Accordingly, in some embodiments, and by way of a non-limiting example, a sensing window for selection of the one or more resource 414, 416, and 416 to be included in the SCI format 2-C may be [m−T0, m−Tproc.0].

In some embodiments, there may be some offset or delay due to processing time delay. In the time event flow 400, the resources to be included in the SCI format 2-C are determined before a resource for transmission of SCI format 2-C is determined. For example, the offset may be equal to T_{proc,0}^{SL}+T_{proc,1}^{SL}.

FIG. 5 depicts another example time-based event flow describing IUC, in accordance with some embodiments. The time flow event 500 shown in FIG. 5 may differ from the time flow event 400 for the resources to be included in the SCI format 2-C are determined after a resource for transmission of SCI format 2-C is determined.

As shown in the time event flow 500, various events are shown along time 502. At time t₀, an explicit request to send resource information may be received 504 at a UE1 102 from a UE2 104 at a time slot n, for example.

Upon receiving the explicit request at time t₀, a resource for IUC transmission may be determined 508. The resource for IUC transmission, for example, may be a resource 504 which may correspond to a resource between time window t₂ and t₃. In some embodiments, and by way of a non-limiting example, a sensing window for selection of the one or more resource for IUC transmission of an SCI format 2-C may be [n−T0, n−Tproc.0].

At time t₁ 506, the UE1 102 may determine resource information 510 of one or more resources shown in FIG. 5 as 512 to be included in the SCI format 2-C as described herein. The one or more resources of 512 to be included in the SCI format 2-C may correspond to a time window t₄ and t₅. In some embodiments, and by way of a non-limiting example, a sensing window for selection of the one or more resource to be included in an SCI format 2-C may be [m−T0, m−Tproc.0] or [m−T0−Tproc.1, m−Tproc.0−Tproc.1], where slot m is the slot of the first selected resource for IUC transmission.

In some embodiments, and by way of a non-limiting example, a time window covering one or more resources of which resource information is sent in the SCI format 2-C may be specified in an explicit request received from the UE2 104 at the UE1 102. In some embodiments, and by way of a non-limiting example, a time window covering one or more resources of which resource information is sent in the SCI format 2-C may be determined by the UE1 102 that may be determined based on meeting a specific criterion.

In some embodiments, and by way of a non-limiting example, a resource 512 to be contained in SCI format 2-C may be determined at a time t₁ that is later than the time t₀ at which an explicit request is received.

In some embodiments, the resource selection window for IUC transmission (e.g., t₂ to t₃) may not be later than a time window covering one or more resources of which resource information is sent in the SCI format 2-C, or may not be later than a latency bound indicated in the explicit request received at time t₀.

In some embodiments, there may be some offset or delay due to processing time delay. In the time event flow 500, the resource selection window for IUC transmission (e.g., t₂ to t₃) may be some offset before a time window covering one or more resources of which resource information is sent in the SCI format 2-C, or may be some offset before a latency bound indicated in the explicit request received at time t₀. For example, the offset may be equal to T_{proc,0}^{SL}+T_{proc,1}^{SL}.

In some embodiments, and by way of a non-limiting example, the time t₁ 506 may be a (pre)configured time period before a time slot m, for example, at time t₀ 504. In some embodiments, there may be some offset or delay due to processing time delay. For example, the offset may be equal to T_{proc,0}^{SL}+T_{proc,1}^{SL}. In the time event flow 500, the resources to be included in the SCI format 2-C are determined after a resource for transmission of SCI format 2-C is determined.

In some embodiments, a UE may perform sidelink reception of physical sidelink control channel (PSCCH) and/or reference signal received power (RSRP) measurements for partial sensing during sidelink discontinuous reception (DRX) inactive time based on resource pool (pre)configuration. Accordingly, a UE may monitor the default periodic sensing occasion for periodic based partial sensing (PBPS) and monitor a minimum of M slots for contiguous partial sensing (CPS).

In some embodiments, for periodic transmission of IUC, a UE may perform CPS for resource selection of M logical slots earlier than slot t_{y0}^{SL} till T_{proc,0}^{SL}+T_{proc,1}^{SL} slots earlier than t_{y0}^{SL}, where t_{y0}^{SL} is the first slot of the selected Y candidate slots of PBPS. In other words, the total number of logical slots for which a UE may perform sensing may be less than M. A UE may also perform CPS for resource re-evaluation and pre-emption checking, as described herein.

In some embodiments, and by way of a non-limiting example, For aperiodic transmission, the CPS monitoring window may start at least M logical slots before t_{y0}^{SL} till T_{proc,0}^{SL}+T_{proc,1}^{SL} slots earlier than t_{y0}^{SL}. In other words, the minimum number of logical slots for which a UE may perform sensing can be less than M. Accordingly, when a UE performs contiguous partial sensing, UE may monitor a minimum of M slots for CPS, which may not be aligned with the intention of power saving. Accordingly, for power saving, a UE may monitor a minimum of (M−T_{proc,0}^{SL′}−T_{proc,1}^{SL′}) logical slots for CPS during SL DRX inactive time according to the resource pool (pre)configuration. Here, T_{proc,0}^{SL′} and T_{proc,1}^{SL′} may be equal to T_{proc,0}^{SL} and T_{proc,1}^{SL} converted in logical slots.

In some embodiments, and by way of a non-limiting example, the value M for aperiodic transmission may be represented by contiguousSensingWindowAperiodic and the value M for periodic transmission may be represented by contiguousSensingWindowPeriodic, which may be separately (pre)configured by resource pool. In some embodiments, a preferred value for M may be a minimum of the two (pre)configured M values.

In some embodiments, and by way of a non-limiting example, whether a UE performs SL reception of PSCCH and RSRP measurement for partial sensing on slots in SL DRX inactive time may be based on (pre)configuration per resource pool when partial sensing is configured in the UE by a higher layer. Accordingly, when partial sensing during SL DRX inactive time if enabled, a UE may perform periodic-based partial sensing for a given Pᵣₑₛₑᵣᵥₑ, during the default periodic sensing occasion, and a UE may perform contiguous partial sensing, UE monitors a minimum of (M−T_{proc,0}^{SL′}−T_{proc,1}^{SL′}) slots for CPS, where T_{proc,0}^{SL′} and T_{proc,1}^{SL′} are equal to T_{proc,0}^{SL} and T_{proc,1}^{SL} converted to logical slots, and M is equal to the minimum of resource pool (pre)configured parameters contiguousSensingWindowAperiodic and contiguousSensingWindowPeriodic.

In some embodiments, and by way of a non-limiting example, a full sensing UE may be configured with sidelink DRX for power saving. In this case, the full sensing UE may perform full sensing during sidelink DRX inactive time if enabled by the resource pool (pre)configuration by a higher layer. The full sensing UE may not be required to perform sidelink reception of PSCCH and RSRP measurement in SL DRX inactive time, if disabled by the resource pool (pre)configuration by a higher layer. To avoid the RAN2 impact, an existing parameter “partialSensingInactiveTime” may be re-used to enable or disable the full sensing on slots in sidelink DRX inactive time, in some embodiments.

Accordingly, in some embodiments, the number of resources to be included in the IUC communication may be based on reception of PSCCH and RSRP measurement for sensing on slots during sidelink discontinuous reception (DRX) inactive time. In some embodiments, and by way of a non-limiting example, sensing on slots during sidelink DRX inactive time may be enabled or disabled by (pre)configuration per resource pool. When sensing on slots during sidelink DRX inactive time is enabled, the UE may perform periodic-based partial sensing for a given period Pᵣₑₛₑᵣᵥₑ. In some embodiments, the given period Pᵣₑₛₑᵣᵥₑ may be a default period.

In some embodiments, the UE may perform contiguous partial sensing (CPS), in which the UE may monitor, for example, a specific number of slots for CPS. The specific number of slots may be given as M−T_{proc,0}^{SL′}−T_{proc,1}^{SL′}. T_{proc,0}^{SL′} and T_{proc,1}^{SL′} may be logical slots of T_{proc,0}^{SL} and T_{proc,1}^{SL}. M may be minimum of contiguousSensingWindowAperiodic and contiguousSensingWindowPeriodic parameters. In some embodiments, M may be maximum of contiguousSensingWindowAperiodic and contiguousSensingWindowPeriodic parameters, or M may be based on contiguousSensingWindowAperiodic or contiguousSensingWindowPeriodic parameter. In some embodiments, the UE may perform full sensing on slots in SL DRX inactive time, based on partialSensingInactiveTime field (pre)configuration.

In some embodiments, a single slot resource may be excluded in the SCI format based on whether additionalPeriodicSensingOccasion field is (pre)configured or not (pre)configured. In resource selection procedure step 6c) of TS 38.214 Section 8.1.4, t′_{n′}^{SL} is defined as slot n if slot n belongs to the set of logical slots (t′₀^{SL}, t′₁^{SL}, . . . , t′_{T′}_{ₘₐₓ}₋₁^{SL}); or defined as the first slot after slot n belonging to the set of logical slots (t′₀^{SL}, t′₁^{SL}, . . . , t′_{T′}_{ₘₐₓ}₋₁^{SL}) if slot n does not belong to the set of logical slots (t′₀^{SL}, t′₁^{SL}, . . . , t′_{T′}_{ₘₐₓ}₋₁^{SL}), where slot n is when the resource selection procedure is triggered.

In full sensing case, all sensing results may be before the resource selection trigger, and hence before slot t′_{n′}^{SL}. However, in partial sensing, the PBPS and CPS may occur after the resource selection trigger. Hence, it may be necessary to delay the reference slot t′_{n′}^{SL}. For partial sensing, the reference slot t′_{n′}^{SL} may be defined based on the last sensing occasion, either from PBPS or CPS. Specifically, if the slot t_{y0}^{SL}−(T_{proc,0}^{SL}+T_{proc,1}^{SL}) belongs to the set (t′₀^{SL}, t′₁^{SL}, . . . , t′_{T′}_{ₘₐₓ}₋₁^{SL}), then the reference slot t_{y0}^{SL} may be equal to t_{y0}^{SL}−(T_{proc,0}^{SL}+T_{proc,1}^{SL}); Otherwise, the reference slot t_{y0}^{SL} may be the first slot after slot t_{y0}^{SL}−(T_{proc,0}^{SL}+T_{proc,1}^{SL}) belonging to the set (t′₀^{SL}, t′₁^{SL}, . . . , t′_{T′}_{ₘₐₓ}₋₁^{SL}), where t_{y0}^{SL} is the first candidate slot of partial sensing.

In some embodiments, and by way of a non-limiting example, in step 6c) of TS 38.214 Section 8.1.4, for partial sensing, if slot t_{y0}^{SL}−(T_{proc,0}^{SL}+T_{proc,1}^{SL}) belongs to the set (t′₀^{SL}, t′₁^{SL}, . . . , t′_{T′}_{ₘₐₓ}₋₁^{SL}), then may be t_{y0}^{SL}−(T_{proc,0}^{SL}+T_{proc,1}^{SL}); Otherwise, t′_{n′}^{SL} may be the first slot after slot t_{y0}^{SL}−(T_{proc,0}^{SL}+T_{proc,1}^{SL}) belonging to the set (t′₀^{SL}, t′₁^{SL}, . . . , t′_{T′}_{ₘₐₓ}₋₁^{SL}), where t_{y0}^{SL} is the first candidate slot of partial sensing.

In some embodiments, and by way of a non-limiting example, in resource selection procedure step 6c) of TS 38.214 Section 8.1.4, T_{scal} may be set to selection window size T₂ converted to units of msec. Accordingly, the actual resource selection window size may be (T₂−T₁). Considering the small value of T₁, the resource selection window size may be approximated by T₂.

In some embodiments, and by way of a non-limiting example, in partial sensing, the use of resource selection window size for T_{scal} may not be proper, since the span of candidate slots may be only a part of the resource selection window. The possible replacement of resource selection window size may be (t_{yL}^{SL}−t_{y0}^{SL}) converted to milliseconds, where t_{yL}^{SL} is the last candidate slot of partial sensing. Similar to full sensing case, T_{scal} may be extended by processing time (T_{proc,0}^{SL}+T_{proc,1}^{SL}) to align with the reference slot t′_{n′}^{SL}.

In some embodiments, the resource selection procedure as described herein may be reused for resource re-evaluation or pre-emption checking. However, for resource re-evaluation or pre-emption checking, the set of Y′ candidate slots may be used to determine T_{scal}.

In some embodiments, In step 6c) of TS 38.214 Section 8.1.4, for partial sensing, T_{scal} may be (t_{yL}^{SL}−t_{y0}^{SL}+T_{proc,0}^{SL}+T_{proc,1}^{SL}) converted to milliseconds. For PBPS, a UE may monitor the most recent sensing occasion for a given reservation periodicity before the first slot of the set of Y or Y′ candidate slots by default. If (pre)configured, a UE may additionally monitor the second most recent sensing occasion for a given reservation periodicity before the first slot of the set of Y or Y′ candidate slots. For the latter case, the value Q in step 6c) of TS 38.214 Section 8.1.4 may be adjusted accordingly.

In the current specification of TS 38.214, if P_{rsvp_RX}<T_{scal} and n′−m≤P′_{rsvp_RX}, then the value Q may be equal to

$$⌈ \frac{{T}_{scal}}{{P}_{rsvp \_ RX}} ⌉$$

otherwise, Q=1. The condition n′−m≤P′_{rsvp_RX} is to ensure the next periodic resource reserved at slot t′ₘ^{SL} is before the reference slot t′_{n′}^{SL}, while the condition P_{rsvp_RX}<T_{scal} indicates the possibility of more than one periodic resource reserved at slot t′ₘ^{SL} is within the resource selection window.

In some embodiment, when a parameter “additionalPeriodicSensingOccasion” is (pre)configured, if P_{rsvp_RX}<T_{scal} and n′−m≤2·P′_{rsvp_RX}, then the value Q may be equal to

$$⌈ \frac{{T}_{scal}}{{P}_{rsvp \_ RX}} ⌉ + 1$$

Here, the condition n′−m≤2·P′_{rsvp_RX} is to ensure the second most recent sensing occasion for a given reservation periodicity is counted in the resource selection window, and the value Q is increased by 1 to compensate the additional reservation periodicity before the starting of the resource selection window. For example, consider that P_{rsvp_RX}=8 ms, P′_{rsvp_RX}=8 slots and T_{scal}=20 ms. If t′ₘ^{SL} is at slot 0 and t′_{n′}^{SL} is at slot 14, then the range of q=2, 3, 4 are within the resource selection window. This implies that value of Q may be extended by 1. For the other cases, the value of Q may be extended by 2, to capture the second most recent sensing occasion for a given reservation periodicity. Accordingly, in step 6c) of TS 38.214 Section 8.1.4, for partial sensing, when the parameter “additionalPeriodicSensingOccasion” is (pre)configured, if P_{rsvp_RX}<T_{scal} and n′−m≤2·P′_{rsvp_RX}, then the value Q may be equal to

$$⌈ \frac{{T}_{scal}}{{P}_{rsvp \_ RX}} ⌉ + 1$$

### Otherwise, Q=2.

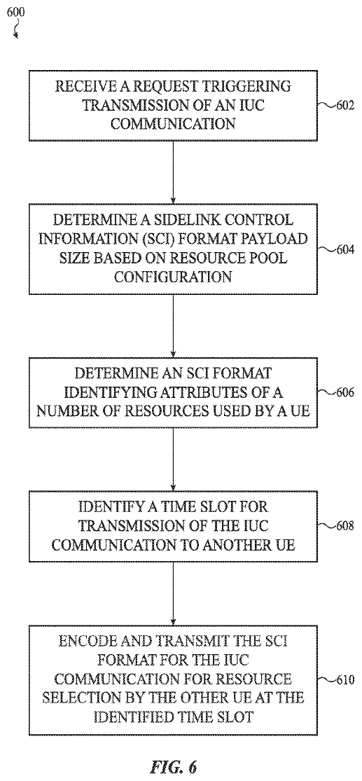

FIG. 6 depicts an example method flow chart for IUC, in accordance with some embodiments. As shown in a method flow chart 600 in FIG. 6, at 602, a request triggering transmission of an inter-UE coordination (IUC) communication may be received from a UE2 104 at a UE1 102. As described herein, the request triggering transmission of an IUC communication may be received at time t₀ in SCI format 2-C as described herein using FIG. 4 or FIG. 5. At 604, the UE1 102 may determine an SCI format payload size as described herein. In some embodiments, for example, the SCI format payload size may be determined based on resource pool (pre)configuration. Once the SCI format payload size is determined at 604, an SCI format or SCI payload identifying attributes of resources to be included in the SCI format may be determined at 606, as described herein. At 608, a time slot for transmission of the SCI format or SCI payload, in other words a time slot for IUC communication, may be determined as described herein using FIG. 4 or FIG. 5, and at 610, the SCI format or SCI payload may be transmitted at the time slot determined at 608 for the IUC communication.

Embodiments contemplated herein include an apparatus having means to perform one or more elements of the method 200, 300, or 600. In the context of method 200, 300, or 600, this apparatus may be, for example, an apparatus of a UE (such as a wireless device 802 that is a UE, as described herein).

Embodiments contemplated herein include one or more non-transitory computer-readable media storing instructions to cause an electronic device, upon execution of the instructions by one or more processors of the electronic device, to perform one or more elements of the method 200, 300, or 600. In the context of method 200, 300, or 600, this non-transitory computer-readable media may be, for example, a memory of a UE (such as a memory 806 of a wireless device 802 that is a UE, as described herein).

Embodiments contemplated herein include an apparatus having logic, modules, or circuitry to perform one or more elements of the method 200, 300, or 600. In the context of method 200, 300, or 600, this apparatus may be, for example, an apparatus of a UE (such as a wireless device 802 that is a UE, as described herein).

Embodiments contemplated herein include an apparatus having one or more processors and one or more computer-readable media, using or storing instructions that, when executed by the one or more processors, cause the one or more processors to perform one or more elements of the method 200, 300, or 600. In the context of method 200, 300, or 600, this apparatus may be, for example, an apparatus of a UE (such as a wireless device 802 that is a UE, as described herein).

Embodiments contemplated herein include a signal as described in or related to one or more elements of the method 200, 300, or 600.

Embodiments contemplated herein include a computer program or computer program product having instructions, wherein execution of the program by a processor causes the processor to carry out one or more elements of the method flow of FIGS. 2, 3, and/or 6. In the context of method flows of FIGS. 2, 3, and/or 6, the processor may be a processor of a UE (such as a processor(s) 804 of a wireless device 802 that is a UE, as described herein), and the instructions may be, for example, located in the processor and/or on a memory of the UE (such as a memory 806 of a wireless device 802 that is a UE, as described herein.

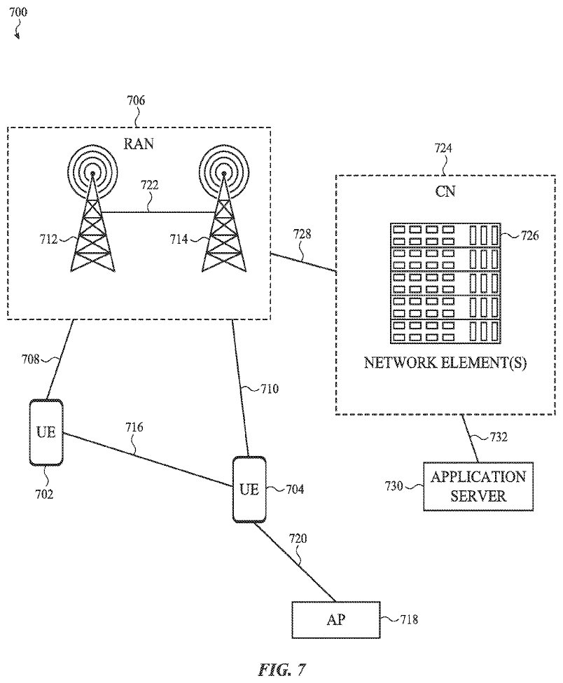

FIG. 7 depicts an example architecture of a wireless communication system of a cellular carrier domain, according to embodiments disclosed herein. The following description is provided for an example wireless communication system 700 that operates in conjunction with the LTE system standards and/or 5G or NR system standards, and/or future standards for 6G, and so on, as provided by 3GPP technical specifications.

As shown by FIG. 7, the wireless communication system 700 includes a UE 702 and a UE 704 (although any number of UEs may be used). In this example, the UE 702 and the UE 704 are illustrated as smartphones (e.g., handheld touchscreen mobile computing devices connectable to one or more cellular networks) but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, that enable the connection 708 and connection 710.

In this example, the connection 708 and connection 710 are air interfaces to enable such communicative coupling and may be consistent with one or more radio access technologies (RATs) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

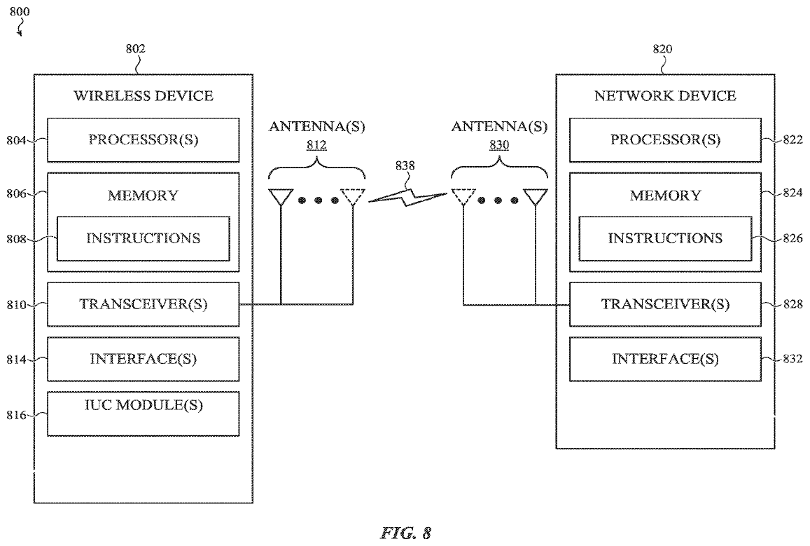

FIG. 8 depicts a system for performing signaling between a UE and a network device, according to embodiments disclosed herein. A system 800 may be a portion of a wireless communications system as herein described. The wireless device 802 may be, for example, a UE of a wireless communication system. The network device 820 may be, for example, a base station or an access point connected to a wireless communication system via wired or wireless communication links.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 838) to and/or from the wireless device 802 with other devices (e.g., the network device 820) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments, the wireless device 802 (e.g., a UE) may communicate with the network device 820 (e.g., a base station or an access point). The wireless device 802 may communicate with the access point via the antennas 812, and the access point may communicate with the network device 820 via a wired or wireless connection.

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include an inter-UE communication module 816 configured to perform various embodiments for inter-UE communication as described herein. The inter-UE communication module 816 may be implemented via hardware, software, or combinations thereof. For example, the inter-UE communication module 816 may be implemented as a processor, circuit, and/or instructions 808 stored in the memory 806 and executed by the processor(s) 804. In some examples, the inter-UE communication module 816 may be integrated within the processor(s) 804 and/or the transceiver(s) 810. For example, the inter-UE communication module 816 may be implemented by a combination of software components (e.g., executed by a DSP or a general processor) and hardware components (e.g., logic gates and circuitry) within the processor(s) 804 or the transceiver(s) 810.

The network device 820 may include one or more processor(s) 822. The processor(s) 822 may execute instructions such that various operations of the network device 820 are performed, as described herein. The processor(s) 822 may include one or more baseband processors implemented using, for example, a CPU, a DSP, an ASIC, a controller, an FPGA device, another hardware device, a firmware device, or any combination thereof configured to perform the operations described herein.

The network device 820 may include a memory 824. The memory 824 may be a non-transitory computer-readable storage medium that stores instructions 826 (which may include, for example, the instructions being executed by the processor(s) 822). The instructions 826 may also be referred to as program code or a computer program. The memory 824 may also store data used by, and results computed by, the processor(s) 822.

The network device 820 may include one or more transceiver(s) 828 that may include RF transmitter and/or receiver circuitry that use the antenna(s) 830 of the network device 820 to facilitate signaling (e.g., the signaling 838) to and/or from the network device 820 with other devices (e.g., the wireless device 802) according to corresponding RATs. In certain embodiments, the signaling 838 may occur via a wired or a wireless network.

The network device 820 may include one or more antenna(s) 830 (e.g., one, two, four, or more). In embodiments having multiple antenna(s) 830, the network device 820 may perform MIMO, digital beamforming, analog beamforming, beam steering, etc., as has been described.

The network device 820 may include one or more interface(s) 832. The interface(s) 832 may be used to provide input to or output from the network device 820. For example, a network device 820 that is a base station may include interface(s) 832 made up of transmitters, receivers, and other circuitry (e.g., other than the transceiver(s) 828/antenna(s) 830 already described) that enables the base station to communicate with other equipment in a core network, and/or that enables the base station to communicate with external networks, computers, databases, and the like for purposes of operations, administration, and maintenance of the base station or other equipment operably connected thereto.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

1-20. (canceled)

21. A baseband processor comprising a memory and configured to:
determine to perform a sidelink reception of at least one of physical sidelink control channel (PSCCH) or reference signal received power (RSRP) measurements for partial sensing during sidelink discontinuous reception (DRX) inactive time based on resource pool (pre)configuration; and
cause a user equipment (UE) to perform contiguous partial sensing (CPS) within a CPS monitoring window defined at least in part by a parameter M, the value of M (pre)configured as a number of logical slots within an aperiodic contiguous sensing window.

22. The baseband processor of claim 1, wherein the CPS monitoring window has a minimum number of logical slots fewer than M logical slots.

23. The baseband processor of claim 1, wherein the CPS monitoring window has fewer than M logical slots.

24. The baseband processor of claim 1, wherein the CPS monitoring window includes a minimum of M−T_{proc,0}^{SL}−T_{proc,1}^{SL} logical slots, where T_{proc,0}^{SL} and T_{proc,1}^{SL} are processing times.

25. The baseband processor of claim 1, wherein the CPS monitoring window has M−T_{proc,0}^{SL}−T_{proc,1}^{SL} logical slots, where T_{proc,0}^{SL} and T_{proc,1}^{SL} are processing times.

26. The baseband processor of claim 1, wherein the partial sensing is configured by a higher layer of the UE.

27. The baseband processor of claim 1, further configured to:
receive from a second UE a request triggering transmission of an inter-UE coordination (IUC) communication to the second UE; and
determine, based on the CPS, a number of resources to be included in the IUC communication.

28. The baseband processor of claim 7, further configured to:
identify a time slot for transmission of the IUC communication to the second UE; and
transmit the IUC communication to the second UE at the identified time slot.

29. A method of a user equipment (UE), comprising:
determining to perform a sidelink reception of at least one of physical sidelink control channel (PSCCH) or reference signal received power (RSRP) measurements for partial sensing during sidelink discontinuous reception (DRX) inactive time based on resource pool (pre)configuration; and
performing contiguous partial sensing (CPS) within a CPS monitoring window defined at least in part by a parameter M, the value of M (pre)configured as a number of logical slots within an aperiodic contiguous sensing window.

30. The method of claim 9, wherein the CPS monitoring window has a minimum number of logical slots fewer than M logical slots.

31. The method of claim 9, wherein the CPS monitoring window has fewer than M logical slots.

32. The method of claim 9, wherein the CPS monitoring window includes a minimum of M−T_{proc,0}^{SL}−T_{proc,1}^{SL} logical slots, where T_{proc,0}^{SL} and T_{proc,1}^{SL} are processing times.

33. The method of claim 9, wherein the CPS monitoring window has M−T_{proc,0}^{SL}−T_{proc,1}^{SL} logical slots, where T_{proc,0}^{SL} and T_{proc,1}^{SL} are processing times.

34. The method of claim 9, wherein the partial sensing is configured by a higher layer of the UE.

35. The method of claim 9, further configured to:
receiving, from a second UE, a request triggering transmission of an inter-UE coordination (IUC) communication to the second UE;
determining, based on the CPS, a number of resources to be included in the IUC communication;
identifying a time slot for transmission of the IUC communication to the second UE; and
transmitting the IUC communication to the second UE at the identified time slot.

36. A user equipment (UE), comprising:
a transceiver; and
a processor configured to,
determine to perform, via the transceiver, a sidelink reception of at least one of physical sidelink control channel (PSCCH) or reference signal received power (RSRP) measurements for partial sensing during sidelink discontinuous reception (DRX) inactive time based on resource pool (pre)configuration; and
perform, via the transceiver, contiguous partial sensing (CPS) within a CPS monitoring window defined at least in part by a parameter M, the value of M (pre)configured as a number of logical slots within an aperiodic contiguous sensing window.

37. The UE of claim 16, wherein the CPS monitoring window has a minimum number of logical slots fewer than M logical slots.

38. The UE of claim 16, wherein the CPS monitoring window has fewer than M logical slots.

39. The UE of claim 16, wherein the CPS monitoring window includes a minimum of M−T_{proc,0}^{SL}−T_{proc,1}^{SL} logical slots, where T_{proc,0}^{SL} and T_{proc,1}^{SL} are processing times.

40. The UE of claim 16, wherein the CPS monitoring window has M−T_{proc,0}^{SL}−T_{proc,1}^{SL} logical slots, where T_{proc,0}^{SL} and T_{proc,1}^{SL} are processing times.
